(19) United States
(12) Patent Application Publication
(10) Pub. No.: US 2026/0263322 A1
(43) Pub. Date: Sep. 10, 2026

(54) METHOD, APPARATUS, ACUPUNCTURE ROBOT, AND STORAGE MEDIUM FOR RECOGNIZING EAR ACUPOINT REFLEX ZONES

(71) Applicant: JIANGHAN UNIVERSITY, WUHAN (CN)

(72) Inventors: QIANG HE, WUHAN (CN); HONGXING ZHANG, WUHAN (CN); QIAN TU, WUHAN (CN)

(21) Appl. No.: 19/234,275

(22) Filed: Jun. 11, 2025

(30) Foreign Application Priority Data
Mar. 5, 2025 (CN) 202510253136.1

(51) Int. Cl. A61H 39/02; A61H 39/04

(52) U.S. Cl. CPC A61H 39/02; A61H 39/04; A61H 2201/1659

(57) ABSTRACT

This invention provides a method, apparatus, acupuncture robot, and storage medium for recognizing ear acupoint reflex zones. The method comprises: performing coarse-grained segmentation on the ear image based on the coarse-grained segmentation module to obtain an ear structure segmentation map and an ear functional area segmentation map; determining the accuracy of the ear functional area segmentation map based on the ear structure segmentation map; when the ear functional area segmentation map is accurate, performing fine-grained segmentation on the ear functional area segmentation map based on the fine-grained segmentation module to obtain the multiple ear acupoint reflex zones. This invention utilizes the relationship between the ear's own structure and functional areas to verify the accuracy of the ear functional area segmentation map, obtaining ear acupoint reflex zones when the ear functional area segmentation map is determined to be accurate, the accuracy of the determined ear acupoint reflex zones is ensured.

### FIELD OF THE DISCLOSURE

The invention relates to the technical fields of acupoint recognition, particularly to a method, apparatus, acupuncture robot, and storage medium for recognizing ear acupoint reflex zones.

### BACKGROUND

Ear acupoints are specific zones distributed on the ear that correspond to various organs and functional systems of the human body. Stimulating these acupoints can regulate physiological and pathological states. Ear acupuncture therapy, a traditional Chinese medical practice, combines meridian theory, visceral theory, and modern medical techniques to prevent and treat diseases by stimulating corresponding reflex zones on the ear. Accurate identification of ear acupoints is critical for effective therapy and is a key component in intelligent acupuncture robots and massage robots.

Existing ear acupoint recognition methods input ear images into pre-trained neural networks to derive results. However, due to the high density and uneven distribution of ear acupoints (such as multiple acupoints in a small area versus sparse acupoints in larger regions), current methods fail to account for these distribution characteristics, leading to low recognition accuracy.

Therefore, there is an urgent need for a method, apparatus, acupuncture robot, and storage medium for recognizing ear acupoint reflex zones to achieve accurate identification of ear acupoints.

### SUMMARY

The invention provides a method, apparatus, acupuncture robot, and storage medium for recognizing ear acupoint reflex zones to address the low accuracy of existing methods caused by neglecting the distribution characteristics of ear acupoints.

In one aspect, the present invention provides a method for recognizing ear acupoint reflex zones, which is used to recognize an ear image based on a hierarchical deep convolutional network model to obtain multiple ear acupoint reflex zones, wherein the hierarchical deep convolutional network model comprises a coarse-grained segmentation module and a fine-grained segmentation module; the method comprises:
performing coarse-grained segmentation on the ear image based on the coarse-grained segmentation module to obtain an ear structure segmentation map and an ear functional area segmentation map;
determining the accuracy of the ear functional area segmentation map based on the ear structure segmentation map;
when the ear functional area segmentation map is accurate, performing fine-grained segmentation on the ear functional area segmentation map based on the fine-grained segmentation module to obtain the multiple ear acupoint reflex zones.

In some possible embodiments, the ear structure segmentation map comprises multiple ear structure regions, and the ear functional area segmentation map comprises multiple ear functional areas; wherein determining the accuracy of the ear functional area segmentation map based on the ear structure segmentation map, comprises:
determining an inclusion relationship between the ear structure regions and the ear functional areas;
determining whether the inclusion relationship conforms to a theoretical inclusion relationship;
when the inclusion relationship conforms to the theoretical inclusion relationship, determining that the ear functional area segmentation map is accurate;
when the inclusion relationship does not conform to the theoretical inclusion relationship, determining that the ear functional area segmentation map is inaccurate.

In some possible embodiments, the multiple ear structure regions comprise an earlobe region, a concha region, a scapha region, an antihelix region, a triangular fossa region, and a helix region; the multiple ear functional areas comprise a head and neck functional area, a circulatory functional area, a respiratory functional area, an endocrine functional area, a digestive functional area, a trunk functional area, an upper limb functional area, a spinal functional area, a lower limb functional area, a urinary functional area, a reproductive functional area, and a neural functional area;
the theoretical inclusion relationship is:
the head and neck functional area is located in the earlobe region and the helix region; the circulatory functional area, the respiratory functional area, and the endocrine functional area are located in the concha region;
the trunk functional area, the spinal functional area, and the lower limb functional area are located in the antihelix region;
the upper limb functional area is located in the scapha region;
the reproductive functional area is located in the triangular fossa region;
the digestive functional area is located in the antihelix region and the concha region;
the urinary functional area is located in the helix region and the concha region;
the neural functional area is located in the antihelix region and the triangular fossa region.

In some possible embodiments, before determining the accuracy of the ear functional area segmentation map based on the ear structure segmentation map, the method further includes the following steps:
acquiring an orientation relationship of the multiple ear structure regions;
determining whether the orientation relationship conforms to a theoretical orientation relationship;
when the orientation relationship conforms to the theoretical orientation relationship, determining that the ear structure segmentation map is accurate;
when the orientation relationship does not conform to the theoretical orientation relationship, determining that the ear structure segmentation map is inaccurate.

In some possible embodiments, the theoretical orientation relationship is:
the earlobe region is adjacent to the concha region, the scapha region, the antihelix region, and the helix region;
the concha region is adjacent to the earlobe region, the antihelix region, and the helix region;
the scapha region is adjacent to the helix region, the antihelix region, and the earlobe region, respectively;
the antihelix region is adjacent to the scapha region, the helix region, and the earlobe region;
the triangular fossa region is adjacent to the antihelix region and the scapha region;
the helix region is adjacent to the earlobe region, the concha region, the scapha region, the antihelix region, and the triangular fossa region.

In some possible embodiments, the multiple ear acupoint reflex zones comprise: within the head-neck functional area: tonsil reflex zone, inner ear reflex zone, eye reflex zone, anterior earlobe reflex zone, jaw reflex zone, tongue reflex zone, tooth reflex zone, occiput reflex zone, anti-tragus apex reflex zone, frontal reflex zone, wheel one reflex zone, wheel two reflex zone, wheel three reflex zone, wheel four reflex zone, nodule reflex zone, and ear tip reflex zone;
within the circulatory functional area: heart reflex zone;
within the respiratory functional area: lung reflex zone and trachea reflex zone;
within the endocrine functional area: endocrine reflex zone;
within the digestive functional area: mouth reflex zone, esophagus reflex zone, cardia reflex zone, stomach reflex zone, spleen reflex zone, liver reflex zone, pancreas and gallbladder reflex zone, duodenum reflex zone, small intestine reflex zone, large intestine reflex zone, rectum reflex zone, ear center reflex zone, and triple energizer reflex zone located;
within the trunk functional area: neck reflex zone, chest reflex zone, abdomen reflex zone, and arm reflex zone located;
within the upper limb functional area: clavicle reflex zone, shoulder reflex zone, elbow reflex zone, wrist reflex zone, and finger reflex zone;
within the spinal functional area: cervical vertebra reflex zone, thoracic vertebra reflex zone, and lumbar-sacral vertebra reflex zone;
within the lower limb functional area: hip reflex zone, knee reflex zone, ankle reflex zone, toe reflex zone, and heel reflex zone;
within the urinary functional area: kidney reflex zone, bladder reflex zone, urethra reflex zone, and anus reflex zone;
within the reproductive functional area: pelvic cavity reflex zone, central angular fossa reflex zone, and internal genitalia reflex zone;
within the neural functional area: shenmen reflex zone and sciatic nerve reflex zone.

In some possible embodiments, the coarse-grained segmentation module comprises a shared feature extraction unit, and a parallel structural coarse-grained segmentation unit and functional coarse-grained segmentation unit; wherein performing coarse-grained segmentation on the ear image based on the coarse-grained segmentation module to obtain an ear structure segmentation map and an ear functional area segmentation map comprises:
extracting features from the ear image based on the shared feature extraction unit to obtain an initial feature map;
performing coarse-grained division on the initial feature map based on the structural coarse-grained segmentation unit to obtain the ear structure segmentation map;
performing coarse-grained division on the initial feature map based on the functional coarse-grained segmentation unit to obtain the ear functional area segmentation map.

In another aspect, the present invention also provides an apparatus for recognizing ear acupoint reflex zones, which is used to recognize an ear image based on a hierarchical deep convolutional network model to obtain multiple ear acupoint reflex zones, wherein the hierarchical deep convolutional network model comprises a coarse-grained segmentation module and a fine-grained segmentation module; the apparatus comprises:
coarse-grained segmentation unit, configured to perform coarse-grained segmentation on the ear image based on the coarse-grained segmentation module to obtain an ear structure segmentation map and an ear functional area segmentation map;
accuracy determination unit, configured to determine the accuracy of the ear functional area segmentation map based on the ear structure segmentation map;
fine-grained segmentation unit, configured to perform fine-grained segmentation on the ear functional area segmentation map based on the fine-grained segmentation module to obtain the multiple ear acupoint reflex zones when the ear functional area segmentation map is accurate.

In another aspect, the present invention also provides an acupuncture robot, which comprises an acupoint-locating subsystem for determining ear acupoint reflex zones and an acupuncture implementation subsystem for performing acupuncture based on the ear acupoint reflex zones, wherein the acupoint-locating subsystem comprises a memory and a processor, wherein:
the memory is configured to store a program;
the processor is coupled to the memory and configured to execute the program stored in the memory to implement the steps of the method for recognizing ear acupoint reflex zones according to any one of the possible embodiment described above.

In another aspect, the present invention also provides a computer-readable storage medium. A program or instructions are stored on the computer-readable storage medium. When the program or instructions are executed by a processor, it can implement the method for recognizing ear acupoint reflex zones described in any of the possible embodiment described above.

The beneficial effects of the present invention are: the method for recognizing ear acupoint reflex zones of the present invention uses a coarse-grained segmentation module to perform coarse-grained segmentation on an ear image to obtain an ear structure segmentation map and an ear functional area segmentation map, and determines the accuracy of the ear functional area segmentation map based on the ear structure segmentation map. By using the relationship between the ear's own structure and functional areas to verify the accuracy of the ear functional area segmentation map, and performing fine-grained segmentation on the ear functional area segmentation map using a fine-grained segmentation module to obtain ear acupoint reflex zones when the ear functional area segmentation map is determined to be accurate, the accuracy of the determined ear acupoint reflex zones is ensured.

Further, the hierarchical deep convolutional network model with coarse-grained and fine-grained segmentation modules retains multi-level information from shallow to deep layers of the ear image for feature extraction at different granularities. Coarse-grained segmentation uses coarse-grained features to ensure accuracy while improving segmentation efficiency, while fine-grained segmentation uses fine-grained features to enhance feature refinement, thereby ensuring the accuracy of recognized ear acupoint reflex zones.

### BRIEF DESCRIPTION OF THE FIGURES

To describe the technical solutions in embodiments of the present invention more clearly, the following briefly introduces the accompanying drawings for describing the embodiments. Apparently, the accompanying drawings in the following description show merely some embodiments of the present invention, and those skilled in the art may still derive other accompanying drawings from these accompanying drawings without making creative efforts.

FIG. 1 is a flowchart of the method for recognizing ear acupoint reflex zones provided by the present invention.

FIG. 2 is a schematic structural diagram of the hierarchical deep convolutional network model provided by the present invention.

FIG. 3 is a flowchart of S102 in FIG. 1 of the present invention.

FIG. 4 is a schematic structural of multiple ear structure regions provided by the present invention.

FIG. 5 is a schematic structural of multiple ear acupoint reflex zones provided by the present invention.

FIG. 6 is a schematic flowchart diagram of verifying the accuracy of an ear structure segmentation map provided by the present invention.

FIG. 7 is a schematic structural diagram of multiple ear acupoint reflex zones provided by the present invention.

FIG. 8 is a schematic structural diagram of the apparatus for recognizing ear acupoint reflex zones provided by the present invention.

FIG. 9 is a schematic structural diagram of the acupuncture robot provided by the present invention.

### DETAILED DESCRIPTION

The following clearly and completely describes the technical solutions in the embodiments of the present invention with reference to the accompanying drawings in the embodiments of the present invention. Apparently, the embodiments described are merely a part rather than all of the embodiments of the present invention. Based on the embodiments in the present invention, all other embodiments obtained by those skilled in the art without making creative efforts shall fall within the scope of protection of the present invention.

It should be understood that the schematic drawings are not drawn in proportion to physical objects. Flowcharts used in the present invention show operations implemented according to some embodiment of the present invention. It should be understood that the operations of the flowcharts can be implemented out of order, and the steps without a logical contextual relationship may be implemented in reverse order or implemented at the same time. In addition, under the guidance of the content of the present invention, those skilled in the art can add one or more other operations to each flowchart, and can also remove one or more operations from each flowchart. Some of block diagrams shown in the accompanying drawings are functional entities and do not necessarily have to correspond to physically or logically separate entities. These functional entities may be implemented in software, or implemented in one or more hardware modules or integrated circuits, or implemented in different network and/or processor systems and/or micro-controller systems.

The reference to “Embodiment” herein means that a particular feature, structure, or characteristic described with reference to the embodiment may be included in at least one embodiment of the present invention. The appearances of the phrases in various places in the specification may not refer to the same embodiment, or to an independent or alternative embodiment that is mutually exclusive of other embodiments. Those skilled in the art explicitly and implicitly understand that the embodiment described herein may be combined with other embodiments.

The present invention provides a method, apparatus, acupuncture robot, and storage medium for recognizing ear acupoint reflex zones, which are described separately.

Before describing specific embodiments, the relationship between acupoints and acupoint reflex zones must be explained. In some industry scenarios, “acupoint” refers to an acupoint point, while“acupoint reflex zone” refers to an area including the acupoint point. In other industry scenarios, the “acupoint” refers to the area where the acupoint is located, so “acupoint reflex zone” has the same meaning as “acupoint.” In other words, the “acupoint reflex zone” refers to an area that can represent the acupoint.

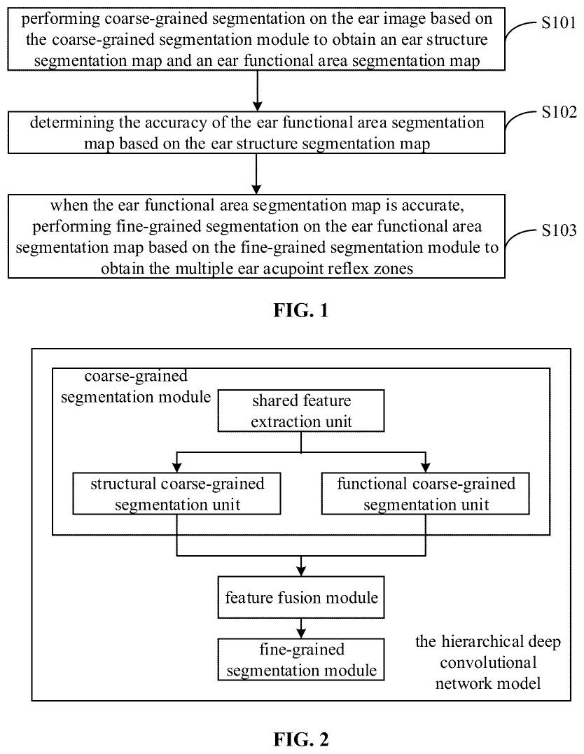

FIG. 1 is a flowchart of the method for recognizing ear acupoint reflex zones, FIG. 2 is a schematic structural diagram of the hierarchical deep convolutional network(HD-CNNs) model. As shown in FIG. 1 and FIG. 2, the hierarchical deep convolutional network model comprises a coarse-grained segmentation module and a fine-grained segmentation module; the method for recognizing ear acupoint reflex zones comprises:
S101, performing coarse-grained segmentation on the ear image based on the coarse-grained segmentation module to obtain an ear structure segmentation map and an ear functional area segmentation map;
S102, determining the accuracy of the ear functional area segmentation map based on the ear structure segmentation map;
S103, when the ear functional area segmentation map is accurate, performing fine-grained segmentation on the ear functional area segmentation map based on the fine-grained segmentation module to obtain the multiple ear acupoint reflex zones.

It should be noted that both the coarse-grained segmentation module and the fine-grained segmentation module are composed of multiple convolutional layers.

It should be understood that before recognizing the ear image based on the hierarchical deep convolutional network model, the model needs to be trained, tested, and verified using a sample dataset to ensure its performance.

In some embodiments of the present invention, to further ensure the recognition accuracy of ear acupoint reflex zones, preprocessing such as denoising and enhancement may be performed on the ear image before S101 to avoid interference from noise and other factors on the recognition result.

Denoising and enhancement are mature image processing methods, which are not elaborated herein.

Compared with the prior art, the method for recognizing ear acupoint reflex zones provided by the present invention uses the coarse-grained segmentation module to perform coarse-grained segmentation on an ear image to obtain the ear structure segmentation map and the ear functional area segmentation map, and determines the accuracy of the ear functional area segmentation map based on the ear structure segmentation map. By using the relationship between the ear's structure and functional areas to verify the accuracy of the ear functional area segmentation map, and performing fine-grained segmentation on the ear functional area segmentation map using the fine-grained segmentation module to obtain ear acupoint reflex zones when the ear functional area segmentation map is determined to be accurate, the accuracy of the determined ear acupoint reflex zones is ensured.

Further, the hierarchical deep convolutional network model with coarse-grained and fine-grained segmentation modules retains multi-level information from shallow to deep layers of the ear image for feature extraction at different granularities. Coarse-grained segmentation uses coarse-grained features to ensure accuracy while improving segmentation efficiency, while fine-grained segmentation uses fine-grained features to enhance feature refinement, thereby ensuring the accuracy of recognized ear acupoint reflex zones.

In some embodiments of the present invention, the ear structure segmentation map comprises multiple ear structure regions, and the ear functional area segmentation map comprises multiple ear functional areas.

Since ear structure regions are inherent features of the ear, and there is an invariant theoretical correlation between ear functional areas and ear structure regions, the accuracy of the segmented ear functional areas can be verified based on this theoretical correlation.

The theoretical correlation may include a theoretical inclusion relationship, a theoretical positional relationship, etc., which are not exhaustively listed herein.

The theoretical inclusion relationship refers to the regional inclusion relationship between ear structure regions and ear functional areas. A certain ear structure region theoretically contains several ear functional areas. The theoretical positional relationship refers to the positional relationship between the center point of an ear functional area and the center point of an ear structure region determined based on an established coordinate system.

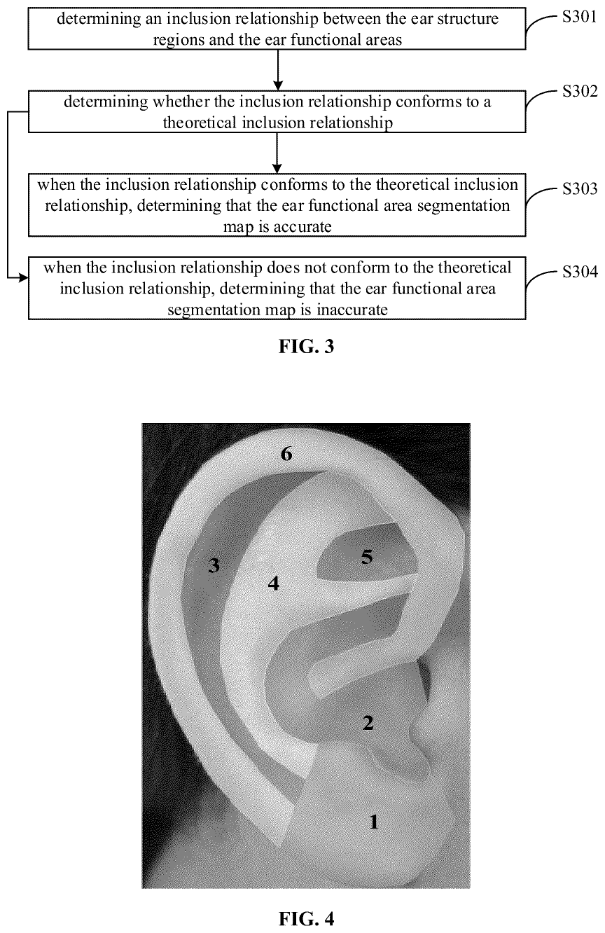

To simplify calculations and improve the efficiency of determining the accuracy of the ear functional area segmentation map, in some embodiments of the present invention, the accuracy of the ear functional area segmentation map is determined based on the theoretical inclusion relationship. Specifically, as shown in FIG. 3, S102 comprises:
S301, determining an inclusion relationship between the ear structure regions and the ear functional areas;
S302, determining whether the inclusion relationship conforms to a theoretical inclusion relationship;
S303, when the inclusion relationship conforms to the theoretical inclusion relationship, determining that the ear functional area segmentation map is accurate;
S304, when the inclusion relationship does not conform to the theoretical inclusion relationship, determining that the ear functional area segmentation map is inaccurate.

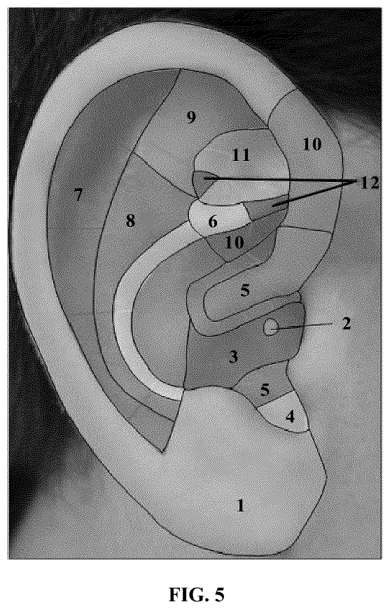

In a specific embodiment of the present invention, as shown in FIG. 4, the multiple ear structure regions comprise an earlobe region 1, a concha region 2, a scapha region 3, an antihelix region 4, a triangular fossa region 5, and a helix region 6. As shown in FIG. 5, the multiple ear functional areas comprise a head and neck functional area 1, a circulatory functional area 2, a respiratory functional area 3, an endocrine functional area 4, a digestive functional area 5, a trunk functional area 6, an upper limb functional area 7, a spinal functional area 8, a lower limb functional area 9, a urinary functional area 10, a reproductive functional area 11, and a neural functional area 12.

The theoretical inclusion relationship is specifically:
the head and neck functional area is located in the earlobe region and the helix region; the circulatory functional area, the respiratory functional area, and the endocrine functional area are located in the concha region;
the trunk functional area, the spinal functional area, and the lower limb functional area are located in the antihelix region;
the upper limb functional area is located in the scapha region;
the reproductive functional area is located in the triangular fossa region;
the digestive functional area is located in the antihelix region and the concha region;
the urinary functional area is located in the helix region and the concha region;
the neural functional area is located in the antihelix region and the triangular fossa region.

By setting the theoretical inclusion relationship between each ear functional area and multiple ear structure regions, the present invention ensures the accuracy of each ear functional area, thereby further improving the accuracy of the determined ear acupoint reflex zones.

As described above, the accuracy of the ear functional area segmentation map is verified based on the ear structure segmentation map, making the accuracy of the ear structure segmentation map crucial. To avoid the technical problem of low accuracy of ear acupoint reflex zones caused by an inaccurate ear structure segmentation map, in some embodiments of the present invention, the method for recognizing ear acupoint reflex zones further comprises verifying the accuracy of the ear structure segmentation map before S102.

The distribution of each ear structure region in the ear structure segmentation map has a theoretical inherent distribution. For example, if the earlobe region is located above the triangular fossa region, the ear structure segmentation map is inaccurate. Therefore, the accuracy of the ear structure segmentation map can be verified based on the theoretical inherent distribution of each ear structure region.

It should be noted that the theoretical inherent distribution of ear structure regions can be characterized by positional parameters, adjacency parameters, etc. Since positional parameters require accurate coordinate information, in a preferred embodiment of the present invention, verification is performed based on adjacency relationships, that is, the theoretical orientation relationship of multiple ear structure regions.

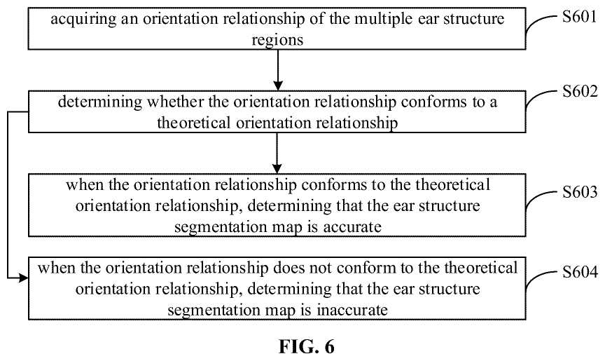

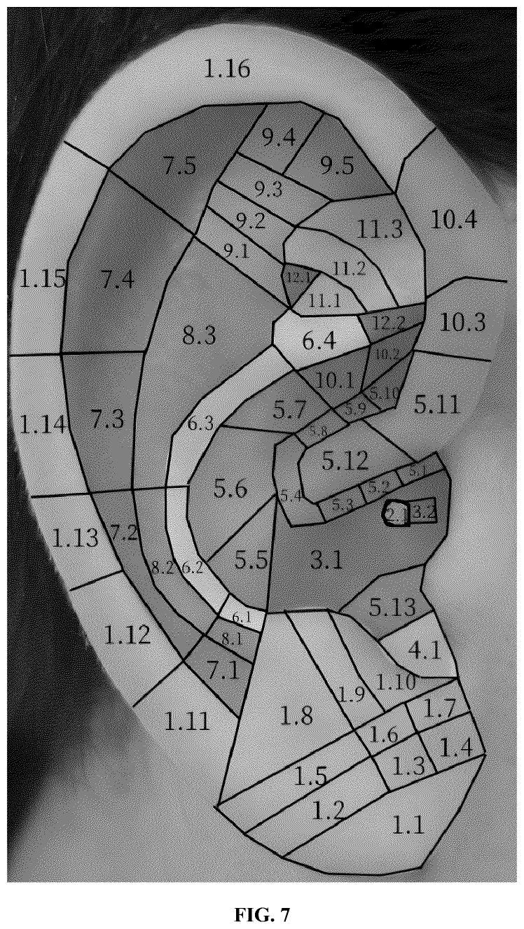

Specifically, as shown in FIG. 6, before S102, the method for recognizing ear acupoint reflex zones further comprises:
S601, acquiring an orientation relationship of the multiple ear structure regions;
S602, determining whether the orientation relationship conforms to a theoretical orientation relationship;
S603, when the orientation relationship conforms to the theoretical orientation relationship, determining that the ear structure segmentation map is accurate;
S604, when the orientation relationship does not conform to the theoretical orientation relationship, determining that the ear structure segmentation map is inaccurate.

The present invention verifies the accuracy of the ear structure segmentation map based on the theoretical orientation relationship before performing S102, ensuring the accuracy of the ear structure segmentation map and thereby improving the accuracy of the finally determined ear acupoint reflex zones.

It should be noted that in some embodiments of the present invention, the hierarchical deep convolutional network model further comprises a feature fusion module disposed between the coarse-grained segmentation module and the fine-grained segmentation module. The feature fusion module is configured to perform the above-mentioned correction process for the ear structure segmentation map and the ear functional area segmentation map, that is, correcting the ear structure regions and ear functional areas based on the theoretical inclusion relationship and orientation relationship. After correction, the ear functional area segmentation map is input into the fine-grained segmentation module for fine-grained segmentation to obtain multiple ear acupoint reflex zones.

In a specific embodiment of the present invention, the theoretical orientation relationship is:
the earlobe region is adjacent to the concha region, the scapha region, the antihelix region, and the helix region;
the concha region is adjacent to the earlobe region, the antihelix region, and the helix region;
the scapha region is adjacent to the helix region, the antihelix region, and the earlobe region, respectively;
the antihelix region is adjacent to the scapha region, the helix region, and the earlobe region;
the triangular fossa region is adjacent to the antihelix region and the scapha region;
the helix region is adjacent to the earlobe region, the concha region, the scapha region, the antihelix region, and the triangular fossa region.

In a specific embodiment of the present invention, the ear acupoint reflex zones obtained by fine-grained segmentation based on the above ear structure regions and ear functional areas are shown in FIG. 7. The ear acupoint reflex zones comprise:
within the head-neck functional area: tonsil reflex zone 1.1, inner ear reflex zone 1.2, eye reflex zone 1.3, anterior earlobe reflex zone 1.4, jaw reflex zone 1.5, tongue reflex zone 1.6, tooth reflex zone 1.7, occiput reflex zone 1.8, anti-tragus apex reflex zone 1.9, frontal reflex zone 1.10, wheel one reflex zone 1.14, wheel two reflex zone 1.13, wheel three reflex zone 1.12, wheel four reflex zone 1.11, nodule reflex zone 1.15, and ear tip reflex zone 1.16;
within the circulatory functional area: heart reflex zone 2.1;
within the respiratory functional area: lung reflex zone 3.1 and trachea reflex zone 3.2;
within the endocrine functional area: endocrine reflex zone 4.1;
within the digestive functional area: mouth reflex zone 5.1, esophagus reflex zone 5.2, cardia reflex zone 5.3, stomach reflex zone 5.4, spleen reflex zone 5.5, liver reflex zone 5.6, pancreas and gallbladder reflex zone 5.7, duodenum reflex zone 5.8, small intestine reflex zone 5.9, large intestine reflex zone 5.10, rectum reflex zone 5.11, ear center reflex zone 5.12, and triple energizer reflex zone 5.13;
within the trunk functional area: neck reflex zone 6.1, chest reflex zone 6.2, abdomen reflex zone 6.3, and arm reflex zone 6.4;
within the upper limb functional area: clavicle reflex zone 7.1, shoulder reflex zone 7.2, elbow reflex zone 7.3, wrist reflex zone 7.4, and finger reflex zone 7.5;
within the spinal functional area: cervical vertebra reflex zone 8.1, thoracic vertebra reflex zone 8.2, and lumbar-sacral vertebra reflex zone 8.3;
within the lower limb functional area: hip reflex zone 9.1, knee reflex zone 9.2, ankle reflex zone 9.3, toe reflex zone 9.4, and heel reflex zone 9.5;
within the urinary functional area: kidney reflex zone 10.1, bladder reflex zone 10.2, urethra reflex zone 10.3, and anus reflex zone 10.4;
within the reproductive functional area: pelvic cavity reflex zone 11.1, central angular fossa reflex zone 11.2, and internal genitalia reflex zone 11.3;
within the neural functional area: shenmen reflex zone 12.1 and sciatic nerve reflex zone 12.2.

To further improve the recognition efficiency of ear acupoint reflex zones, in some embodiments of the present invention, as shown in FIG. 2, the coarse-grained segmentation module comprises a shared feature extraction unit, and a parallel structural coarse-grained segmentation unit and functional coarse-grained segmentation unit; S101 comprises:
extracting features from the ear image based on the shared feature extraction unit to obtain an initial feature map;
performing coarse-grained division on the initial feature map based on the structural coarse-grained segmentation unit to obtain the ear structure segmentation map;
performing coarse-grained division on the initial feature map based on the functional coarse-grained segmentation unit to obtain the ear functional area segmentation map.

The present invention extracts an initial feature map of the ear image through the shared feature extraction unit, which can be simultaneously used by the parallel structural coarse-grained segmentation unit and functional coarse-grained segmentation unit for recognition, enabling simultaneous recognition of the ear structure segmentation map and ear functional area segmentation map, reducing recognition time, and thereby improving the recognition efficiency of ear acupoint reflex zones.

It should be understood that the shared feature extraction unit, structural coarse-grained segmentation unit, and functional coarse-grained segmentation unit are all composed of multiple convolutional layers.

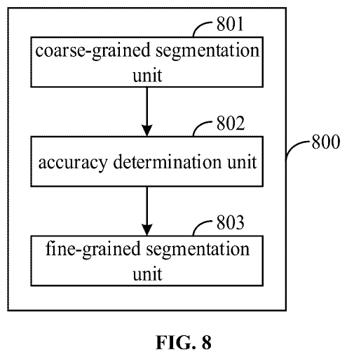

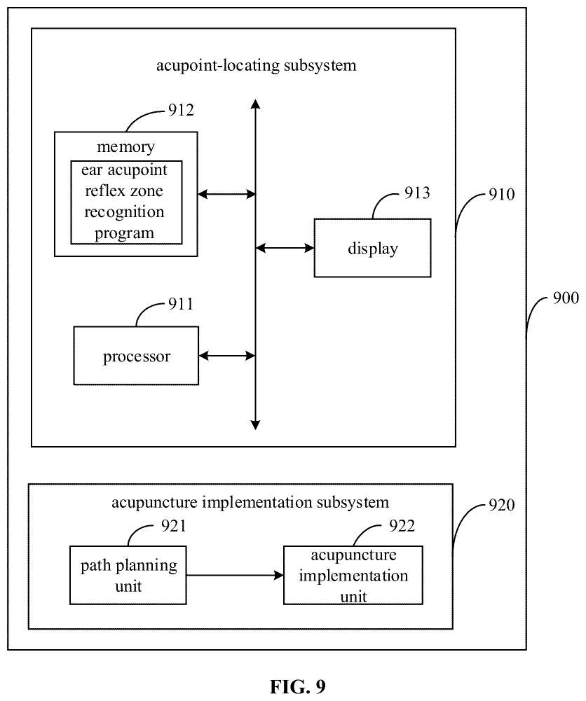

To better implement the method for recognizing ear acupoint reflex zones in the embodiments of the present invention, correspondingly, the present invention further provides an apparatus for recognizing ear acupoint reflex zones for recognizing an ear image based on a hierarchical deep convolutional network model to obtain multiple ear acupoint reflex zones, wherein the hierarchical deep convolutional network model comprises a coarse-grained segmentation module and a fine-grained segmentation module. As shown in FIG. 8, the apparatus for recognizing ear acupoint reflex zones 800 comprises:
coarse-grained segmentation unit 801, configured to perform coarse-grained segmentation on the ear image based on the coarse-grained segmentation module to obtain an ear structure segmentation map and an ear functional area segmentation map;
accuracy determination unit 802, configured to determine whether the ear functional area segmentation map is accurate based on the ear structure segmentation map;
fine-grained segmentation unit 803, configured to perform fine-grained segmentation on the ear functional area segmentation map based on the fine-grained segmentation module to obtain the multiple ear acupoint reflex zones when the ear functional area segmentation map is accurate.

The apparatus for recognizing ear acupoint reflex zones 800 provided in the above embodiment can implement the technical solutions described in the method for recognizing ear acupoint reflex zones. The specific principles implemented by the above modules or units can be found in the corresponding content of the method for recognizing ear acupoint reflex zones, which is not repeated herein.

As shown in FIG. 9, the present invention further provides an acupuncture robot 900. The acupuncture robot 900 comprises an acupoint-locating subsystem 910 for determining ear acupoint reflex zones and an acupuncture implementation subsystem 920 for performing acupuncture based on the ear acupoint reflex zones. The acupoint-locating subsystem 910 comprises a processor 911, a memory 912, and a display 913. FIG. 9 only shows some components of the acupuncture robot 900, but it should be understood that not all shown components are required, and more or fewer components may be alternatively implemented.

The memory 912 can be an internal storage unit of the acupoint-locating subsystem 910 in some embodiments, such as a hard disk or memory of the acupoint-locating subsystem 910. In other embodiments, the memory 912 can also be an external storage device of the acupoint-locating subsystem 910, such as a plug-in hard disk, smart media card (SMC), secure digital (SD) card, flash card, etc., equipped with the acupoint-locating subsystem 910.

Further, the memory 912 can include both internal storage units and external storage devices of the acupoint-locating subsystem 910. The memory 912 is used to store application software installed in the acupoint-locating subsystem 910 and various types of data.

The processor 911 can be a central processing unit (CPU), microprocessor, or other data processing chips in some embodiments, configured to run program code stored in the memory 912 or process data, such as the method for recognizing ear acupoint reflex zones in the present invention.

The display 913 can be an LED display, liquid crystal display, touch liquid crystal display, or OLED (Organic Light-Emitting Diode) touch display in some embodiments. The display 913 is used to display information of the acupoint-locating subsystem 910 and a visual user interface. Components 911-913 of the acupoint-locating subsystem 910 communicate with each other via a system bus.

In some embodiments of the present invention, when the processor 911 executes the ear acupoint reflex zone recognition program in the memory 912, the following steps may be implemented:
performing coarse-grained segmentation on the ear image based on the coarse-grained segmentation module to obtain an ear structure segmentation map and an ear functional area segmentation map;
determining the accuracy of the ear functional area segmentation map based on the ear structure segmentation map;
when the ear functional area segmentation map is accurate, performing fine-grained segmentation on the ear functional area segmentation map based on the fine-grained segmentation module to obtain the multiple ear acupoint reflex zones.

It should be understood that when the processor 911 executes the ear acupoint reflex zone recognition program in the memory 912, in addition to the above mentioned functions, it can also implement other functions. For specific details, please refer to the descriptions of the relevant method embodiments above.

As shown in FIG. 9, the acupuncture implementation subsystem 920 comprises a path planning unit 921 and an acupuncture implementation unit 922. The path planning unit 921 is configured to plan a path based on the position of the acupuncture needle in the acupuncture implementation unit 922 and the acupoint coordinates to generate a planned path, and the acupuncture implementation unit 922 moves the acupuncture needle to the location of the acupoint reflex zone for acupuncture based on the planned path.

By providing the acupuncture robot 900, the present invention can replace doctors in long-term acupuncture treatment, reducing doctor workload and medical costs.

Correspondingly, the present invention further provides a computer-readable storage medium for storing computer-readable programs or instructions, which, when executed by a processor, can implement the steps or functions of the method for recognizing ear acupoint reflex zones provided in the above method embodiments.

Those skilled in the art can understand that all or part of the processes in the above method embodiments can be implemented by a computer program instructing related hardware, such as a processor or controller. The computer program can be stored in a computer-readable storage medium, such as a disk, an optical disk, a read-only memory (ROM), or a random access memory (RAM).

The method for recognizing ear acupoint reflex zones, apparatus, acupuncture robot, and storage medium provided by the present invention have been described in detail above. Specific examples were applied herein to explain the principles and implementation of the present invention. The description of the above embodiments is only used to help understand the method of the present invention and its core idea. Meanwhile, those skilled in the art may vary the specific implementation and application scope according to the idea of the present invention. In summary, the content of this specification should not be construed as a limitation of the present invention.

What is claimed is:

1. A method for recognizing ear acupoint reflex zones, which is used to recognize an ear image based on a hierarchical deep convolutional network model to obtain multiple ear acupoint reflex zones, wherein the hierarchical deep convolutional network model comprises a coarse-grained segmentation module and a fine-grained segmentation module;
the method comprises:
performing coarse-grained segmentation on the ear image based on the coarse-grained segmentation module to obtain an ear structure segmentation map and an ear functional area segmentation map;
determining the accuracy of the ear functional area segmentation map based on the ear structure segmentation map;
when the ear functional area segmentation map is accurate, performing fine-grained segmentation on the ear functional area segmentation map based on the fine-grained segmentation module to obtain the multiple ear acupoint reflex zones;
the ear structure segmentation map comprises multiple ear structure regions, and the ear functional area segmentation map comprises multiple ear functional areas; wherein determining the accuracy of the ear functional area segmentation map based on the ear structure segmentation map, comprises:
determining an inclusion relationship between the ear structure regions and the ear functional areas;
determining whether the inclusion relationship conforms to a theoretical inclusion relationship;
when the inclusion relationship conforms to the theoretical inclusion relationship, determining that the ear functional area segmentation map is accurate;
when the inclusion relationship does not conform to the theoretical inclusion relationship, determining that the ear functional area segmentation map is inaccurate;
the multiple ear structure regions comprise an earlobe region, a concha region, a scapha region, an antihelix region, a triangular fossa region, and a helix region; the multiple ear functional areas comprise a head and neck functional area, a circulatory functional area, a respiratory functional area, an endocrine functional area, a digestive functional area, a trunk functional area, an upper limb functional area, a spinal functional area, a lower limb functional area, a urinary functional area, a reproductive functional area, and a neural functional area;
the theoretical inclusion relationship is:
the head and neck functional area is located in the earlobe region and the helix region;
the circulatory functional area, the respiratory functional area, and the endocrine functional area are located in the concha region;
the trunk functional area, the spinal functional area, and the lower limb functional area are located in the antihelix region;
the upper limb functional area is located in the scapha region;
the reproductive functional area is located in the triangular fossa region;
the digestive functional area is located in the antihelix region and the concha region;
the urinary functional area is located in the helix region and the concha region;
the neural functional area is located in the antihelix region and the triangular fossa region.

2. The method for recognizing ear acupoint reflex zones of claim 1, before determining the accuracy of the ear functional area segmentation map based on the ear structure segmentation map, the method further comprises:
acquiring an orientation relationship of the multiple ear structure regions;
determining whether the orientation relationship conforms to a theoretical orientation relationship;
when the orientation relationship conforms to the theoretical orientation relationship, determining that the ear structure segmentation map is accurate;
when the orientation relationship does not conform to the theoretical orientation relationship, determining that the ear structure segmentation map is inaccurate.

3. The method for recognizing ear acupoint reflex zones of claim 2, the theoretical orientation relationship is:
the earlobe region is adjacent to the concha region, the scapha region, the antihelix region, and the helix region;
the concha region is adjacent to the earlobe region, the antihelix region, and the helix region;
the scapha region is adjacent to the helix region, the antihelix region, and the earlobe region, respectively;
the antihelix region is adjacent to the scapha region, the helix region, and the earlobe region;
the triangular fossa region is adjacent to the antihelix region and the scapha region;
the helix region is adjacent to the earlobe region, the concha region, the scapha region, the antihelix region, and the triangular fossa region.

4. The method for recognizing ear acupoint reflex zones of claim 1, the multiple ear acupoint reflex zones comprise:
within the head-neck functional area: tonsil reflex zone, inner ear reflex zone, eye reflex zone, anterior earlobe reflex zone, jaw reflex zone, tongue reflex zone, tooth reflex zone, occiput reflex zone, anti-tragus apex reflex zone, frontal reflex zone, wheel one reflex zone, wheel two reflex zone, wheel three reflex zone, wheel four reflex zone, nodule reflex zone, and ear tip reflex zone;
within the circulatory functional area: heart reflex zone;
within the respiratory functional area: lung reflex zone and trachea reflex zone;
within the endocrine functional area: endocrine reflex zone;
within the digestive functional area: mouth reflex zone, esophagus reflex zone, cardia reflex zone, stomach reflex zone, spleen reflex zone, liver reflex zone, pancreas and gallbladder reflex zone, duodenum reflex zone, small intestine reflex zone, large intestine reflex zone, rectum reflex zone, ear center reflex zone, and triple energizer reflex zone located;
within the trunk functional area: neck reflex zone, chest reflex zone, abdomen reflex zone, and arm reflex zone located;
within the upper limb functional area: clavicle reflex zone, shoulder reflex zone, elbow reflex zone, wrist reflex zone, and finger reflex zone;
within the spinal functional area: cervical vertebra reflex zone, thoracic vertebra reflex zone, and lumbar-sacral vertebra reflex zone;
within the lower limb functional area: hip reflex zone, knee reflex zone, ankle reflex zone, toe reflex zone, and heel reflex zone;
within the urinary functional area: kidney reflex zone, bladder reflex zone, urethra reflex zone, and anus reflex zone;
within the reproductive functional area: pelvic cavity reflex zone, central angular fossa reflex zone, and internal genitalia reflex zone;
within the neural functional area: shenmen reflex zone and sciatic nerve reflex zone.

5. The method for recognizing ear acupoint reflex zones of claim 1, the coarse-grained segmentation module comprises a shared feature extraction unit, and a parallel structural coarse-grained segmentation unit and functional coarse-grained segmentation unit; wherein performing coarse-grained segmentation on the ear image based on the coarse-grained segmentation module to obtain an ear structure segmentation map and an ear functional area segmentation map comprises:
extracting features from the ear image based on the shared feature extraction unit to obtain an initial feature map;
performing coarse-grained division on the initial feature map based on the structural coarse-grained segmentation unit to obtain the ear structure segmentation map;
performing coarse-grained division on the initial feature map based on the functional coarse-grained segmentation unit to obtain the ear functional area segmentation map.

6. An apparatus for recognizing ear acupoint reflex zones, which is used to recognize an ear image based on a hierarchical deep convolutional network model to obtain multiple ear acupoint reflex zones, wherein the hierarchical deep convolutional network model comprises a coarse-grained segmentation module and a fine-grained segmentation module;
the apparatus comprises:
coarse-grained segmentation unit, configured to perform coarse-grained segmentation on the ear image based on the coarse-grained segmentation module to obtain an ear structure segmentation map and an ear functional area segmentation map;
accuracy determination unit, configured to determine the accuracy of the ear functional area segmentation map based on the ear structure segmentation map;
fine-grained segmentation unit, configured to perform fine-grained segmentation on the ear functional area segmentation map based on the fine-grained segmentation module to obtain the multiple ear acupoint reflex zones when the ear functional area segmentation map is accurate;
the ear structure segmentation map comprises multiple ear structure regions, and the ear functional area segmentation map comprises multiple ear functional areas; wherein determining the accuracy of the ear functional area segmentation map based on the ear structure segmentation map, comprises:
determining an inclusion relationship between the ear structure regions and the ear functional areas;
determining whether the inclusion relationship conforms to a theoretical inclusion relationship;
when the inclusion relationship conforms to the theoretical inclusion relationship, determining that the ear functional area segmentation map is accurate;
when the inclusion relationship does not conform to the theoretical inclusion relationship, determining that the ear functional area segmentation map is inaccurate;
the multiple ear structure regions comprise an earlobe region, a concha region, a scapha region, an antihelix region, a triangular fossa region, and a helix region; the multiple ear functional areas comprise a head and neck functional area, a circulatory functional area, a respiratory functional area, an endocrine functional area, a digestive functional area, a trunk functional area, an upper limb functional area, a spinal functional area, a lower limb functional area, a urinary functional area, a reproductive functional area, and a neural functional area;
the theoretical inclusion relationship is:
the head and neck functional area is located in the earlobe region and the helix region;
the circulatory functional area, the respiratory functional area, and the endocrine functional area are located in the concha region;
the trunk functional area, the spinal functional area, and the lower limb functional area are located in the antihelix region;
the upper limb functional area is located in the scapha region;
the reproductive functional area is located in the triangular fossa region;
the digestive functional area is located in the antihelix region and the concha region;
the urinary functional area is located in the helix region and the concha region;
the neural functional area is located in the antihelix region and the triangular fossa region.

7. An acupuncture robot, comprising an acupoint-locating subsystem for determining ear acupoint reflex zones and an acupuncture implementation subsystem for performing acupuncture based on the ear acupoint reflex zones, wherein the acupoint-locating subsystem comprises a memory and a processor, wherein:
the memory is configured to store a program;
the processor is coupled to the memory and configured to execute the program stored in the memory to implement the steps of the method for recognizing ear acupoint reflex zones described in the claim 1.

8. A computer-readable storage medium is used to store a computer-readable program or instruction that, when executed by the processor, is capable of fulfilling the steps in the method for recognizing ear acupoint reflex zones described in the claim 1.
